(19) United States
(12) Patent Application Publication
(10) Pub. No.: US 2026/0093783 A1
(43) Pub. Date: Apr. 2, 2026

(54) INTER-GROUP CONFORMAL SCORING FAIRNESS WITH SET SIZE CALIBRATION

(71) Applicant: THE TORONTO-DOMINION BANK, TORONTO (CA)

(72) Inventors: Jesse Cole Cresswell, TORONTO (CA); Bhargava Kumar, JERSEY CITY, NJ (US); Yi Sui, NEWMARKET (CA); Mouloud-Beallah Belbahri, LAVAL (CA); Maksims Volkovs, TORONTO (CA)

(21) Appl. No.: 19/345,940

(22) Filed: Sep. 30, 2025

Related U.S. Application Data
(60) Provisional application No. 63/702,397, filed on Oct. 2, 2024.

(51) Int. Cl. G06F 18/241; G06F 16/28

(52) U.S. Cl. CPC G06F 18/241; G06F 16/285

(57) ABSTRACT

Approaches that intend to reduce disparate impact, particularly those for providing equal coverage sets in conformal prediction, can in fact increase disparate impact for human-in-the-loop systems. To improve these systems, rather than optimizing selection processes for a class prediction set for a confidence level (e.g., a percentage confidence that the correct class is in the class prediction set), a selection process is determined that reduces the set size difference across groups.

### CROSS-REFERENCE TO RELATED APPLICATION

This application claims the benefit of U.S. Provisional Application No. 63/702,397, filed on Oct. 2, 2024, the contents of which is hereby incorporated by reference in its entirety.

### BACKGROUND

This disclosure relates generally to computer modeling and more particularly to classification models used to inform human actions.

In general, classification models predict membership of a particular data instance with respect to a set of classes. In general, membership in the classes may also be associated with a particular action to be taken when an item is designated as a member of the class. For example, the classes may describe actions to perform for a user, such as whether to authorize a user to access a resource or to reject the resource access. Classification may also include object classification, categorization, and other types of classification tasks. Such classification models often output a score with respect to individual classes that may or may not be normalized (i.e., may or may not represent a “percent” prediction for each class) and typically are not calibrated across the classes. Often, the class with the highest raw output score for a class is considered the predicted class by the model.

In practice, model users must be careful with the interpretation of raw scores. Raw class prediction scores generally do not correspond to the probability that an input sample belongs to a particular class, unless they are properly calibrated. Generally, models trained by statistical routines, advanced analytics, or machine learning and artificial intelligence are not calibrated correctly by default. Usually, the calibration of the model must be checked using a calibration dataset not previously seen by the model; if calibration is unsatisfactory, raw score values can be corrected with a separate calibration model.

Even for a calibrated model, the raw scores of the model do not represent model uncertainty or the difficulty of classifying a data sample relative to other classes. For example, a binary classifier may indicate the same raw scores for one data sample that is similar to data seen during the training and for another data sample that is unlike any data seen during training, despite the significantly different certainty inherent in these predictions. Hence, even for a calibrated model, the uncertainty is not captured by the value of the scores output for particular classes.

These effects may make it difficult to effectively use model predictions with confidence or with a limitation on the potential error rates of the model predictions. As a result, it may also be difficult to effectively determine which predictions to evaluate with an escalated review process or manual review.

One approach for addressing these problems, Conformal Prediction (CP), is one way of rigorously quantifying this uncertainty. The output of the conformal prediction model is a “class prediction set” that defines a set of likely classes for the input. To communicate uncertainty, class prediction set is larger when the classification model is more uncertain about the correct answer.

However, using this type of quantification for human-in-the-loop decisions, where the class prediction set is provided for human review and approval (e.g., with additional information about the model's predictions), may cause unexpected and undesired effects. As discussed further below, although this approach is intended to guarantee coverage and improve human decision-making by aiding it with model evaluation, in practice, certain groups may experience disparate treatment when class prediction sets are constructed in typical ways.

### SUMMARY

In many cases, class prediction sets may yield undesired disparities across different groups within the dataset, particularly when used with human review of the class outputs. Paradoxically, per-group configuration of conformal prediction to obtain equal coverage (e.g., 90% confidence for each group) can yield increased disparity in accuracy when humans review the resulting coverage sets that, in theory, have the same calibrated confidence with respect to different groups.

To reduce the accuracy disparity between groups, rather than optimize to equalize the coverage of the class prediction sets, the selection process for constructing class prediction sets is configured to reduce the difference in set sizes obtained for different groups. When similar set sizes for different groups are provided to human reviewers (even when the confidence level of the class membership groups significantly differs), the ensuing human review has reduced accuracy disparities. This enables model-aided review to improve and inform human evaluations without inadvertently encouraging group disparities.

To do so, selection processes for assigning classes to class prediction sets are evaluated to determine the set size differences across group labels. That is, for a calibration group of data samples having multiple labels, class predictions are applied to a selection process to determine the resulting class prediction sets for each group label and the resulting inter-group set size difference. The inter-group size difference may describe a difference in: class prediction set distribution across the groups, mean or mode of membership set size, frequency of a particular set size (e.g., single-class sets), and so forth.

The selection process may be calibrated or otherwise modified to reduce the set size differences across group labels. As one example, parameters of the selection process may be selected or otherwise modified based on the inter-group set size difference. As another example, different selection processes may be applied and used to determine respective inter-group set size difference, such that the selection process with the smaller inter-group set size difference may be selected.

Each selection process may include one or more selection algorithms that determine class membership in the class prediction set. The different selection processes may include, for example, applying different selection algorithms such as conformal prediction or avg-k to select the class prediction set. As another example, the selection processes may include differing selection algorithms or different parameters applied to different groups. For example, an evaluated selection process may include a selection algorithm with different conformal scoring or different conformal thresholds applied to each group to yield similar class set sizes. These approaches may still enable determination of confidence levels, enabling improved human evaluation with class prediction sets while reducing potential inter-group disparities.

### BRIEF DESCRIPTION OF THE DRAWINGS

FIG. 1 illustrates a computer modeling system for training and applying a classification model, according to one or more embodiments.

FIG. 2. illustrates an overview of conformal scores and a conformal threshold used for class membership prediction, according to one or more embodiments.

FIGS. 3 and 4 show example processes for training a classification model and a conformal threshold, according to one or more embodiments.

FIG. 5 shows an example of inter-group accuracy for human-in-the-loop decisions, according to one or more embodiments.

FIGS. 6A-6B show examples data flows for evaluating selection processes with a set size difference, according to one or more embodiments.

FIG. 7 shows example experimental results of various selection processes and resulting human accuracy disparity.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

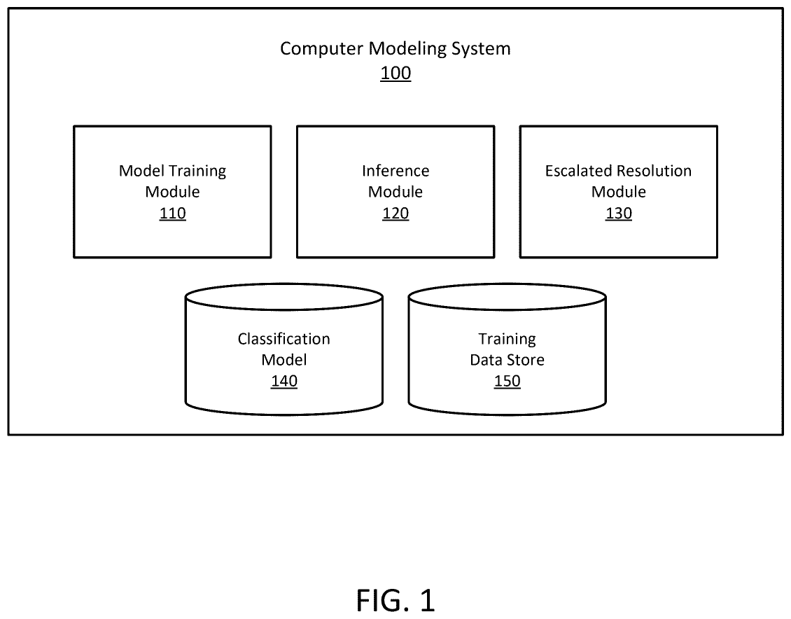

FIG. 1 illustrates a computer modeling system 100 for training and applying a classification model 140, according to one or more embodiments. The classification model 140 may be any type of computer-trained model with parameters learned through a training process that evaluates membership of an input (also termed an “input data sample” or “data instance”) with respect to two or more classes. The computer modeling system 100 includes a set of computing modules for training and applying the classification model 140, along with a training data store 150 including a set of training data for training the parameters of the classification model 140. Alternative embodiments may include more, fewer, or different components from those illustrated in FIG. 1, and the functionality of each component may be divided between the components differently from the description below.

Additionally, the computer modeling system 100 may also communicate with one or more other systems to exchange information, which are not shown in FIG. 1 for convenience. The computer modeling system 100 may communicate with other systems and various user devices, for example, to receive training or other data, to receive input samples for inference analyses, to receive inputs from a user of the computer modeling system 100, to transmit results of inference analyses, and so forth.

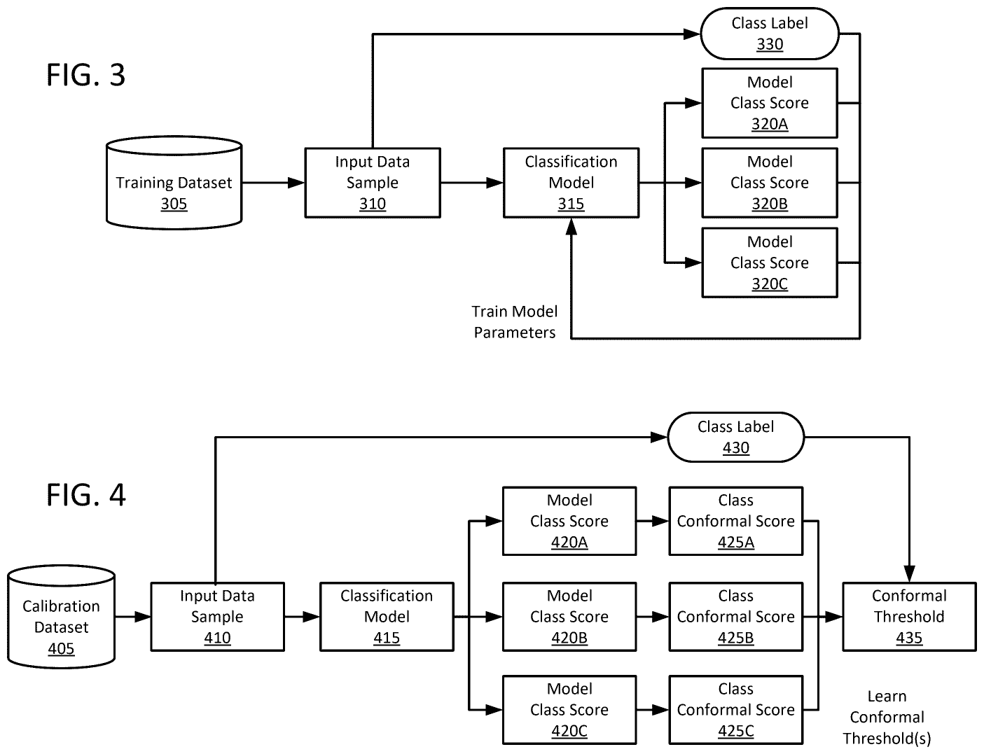

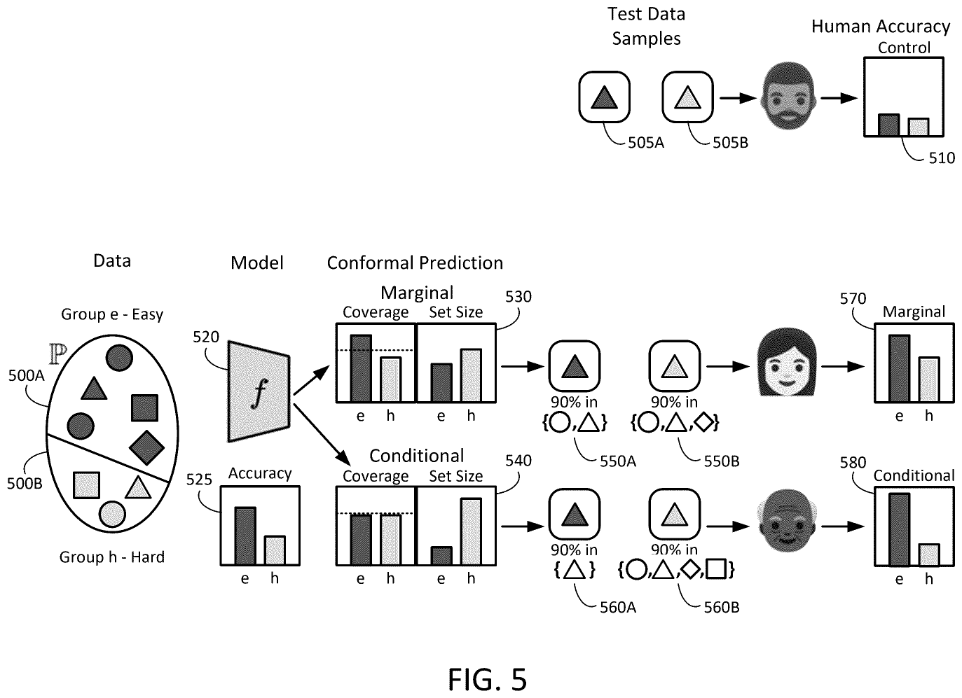

The computer modeling system 100 may use a classification model 140 to automatically predict a class for a received data sample and apply a related action. The classification model 140 is a machine-learning model that is trained to generate output scores (“raw scores”) for each class of a plurality of classes. The classification model 140 may use, in various embodiments, heuristics, statistics, advanced analytics, machine learning, artificial intelligence, or other methods for generating output scores. As further described in conjunction with FIGS. 3 and 4, the classification model 140 may be trained with labeled data samples in a training dataset, e.g., data samples stored by the training data store 150.

Once trained, the classification model 140 may be used in one or more applications for authorization and access to systems, risk analysis (e.g., system intrusion), financial and/or credit risk analysis, medical risk analysis (e.g., mortality or long-term health diagnoses), image processing classification, or the like. In other embodiments, the classification model 140 may be used in any other suitable application in which risk or uncertainty may be quantified.

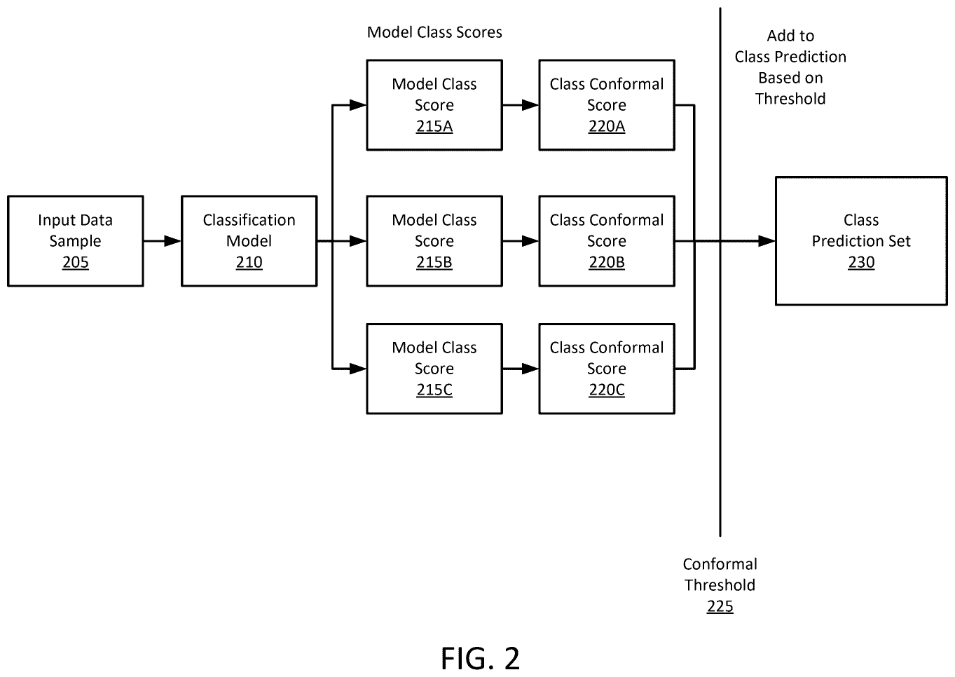

Specifically, and as discussed further in conjunction with FIG. 2, when the classification model 140 receives input data, the classification model generates output scores for each class. Rather than directly use the output scores from the model, the output scores are evaluated to determine a class prediction set indicating likely classes for the data sample based on a selection process that can also provide a calibrated confidence level (e.g., 90% confident) that the correct class is in the class prediction set. As one selection algorithm for the class prediction set, conformal prediction (CP) uses conformal scores in combination with a conformal threshold for selecting classes of the class prediction set. Conformal scores describe agreement of the output scores for the various classes. The conformal scores are then evaluated with respect to a calibrated conformal threshold to indicate membership in the class (e.g., as a Boolean). Using the conformal scores and the conformal threshold, the class membership may have a known confidence level/error rate of class membership designations. Other selection algorithms may be used for the class prediction set as discussed further below.

In some embodiments, the classification model 140 is trained with a model training module 110 using training data samples stored in training data store 150. Generally, the training data includes training data samples used to train parameters of the classification model 140 (for generating class output scores) and additionally includes data samples used to determine the selection process for the class prediction set. The training data store 150 thus may include two separate datasets: training data and calibration data. Training of the classification model 140 and calibration thresholds are discussed further below.

The training data store 150 and application of the classification model 140 may also be performed on data samples having different group labels. The group labels in certain embodiments may not be included with the data sample for evaluation by the classification model 140. The group labels may represent characteristics or aspects of the data samples to be evaluated for fairness and resulting accuracy of the classification model 140 and manual review augmented by the classification model predictions. As discussed further below, the classification model 140 and construction of the class prediction set may affect accuracy of different groups differently. In many situations, the group labels may represent personal characteristics, legally protected categories, or other aspects of the data to be evaluated for inter-group set differences (e.g., to measure or detect disparate impact). As discussed in detail below, the selection process for the class prediction set may be configured to reduce inter-group accuracy error by reducing the inter-group set size differences between the classification group sets of different groups.

An inference module 120 receives new data samples for classification and evaluates the received data samples with respect to the classification model 140. Based on the selection process, the inference module 120 identifies a class prediction set comprising one or more classes predicted by the classification model for the data samples. The number of classes in the class prediction set may then be used to characterize the confidence of the model and, in some embodiments, may inform human review of the data sample. In some configurations, the class prediction set determines whether the model class score should be used or the data sample should be further evaluated. In these embodiments, the inference module 120 evaluates whether a single class is predicted, in which case the model may be confident about that single class. If no class is predicted or multiple classes are predicted, this indicates uncertainty in the overall prediction, as either no class passed the predictive threshold and results in an empty class prediction set, or that multiple classes passed the predictive threshold and results in a class prediction set consisting of multiple classes. As such, when no class is predicted or multiple classes are predicted, the inference module 120 may provide the data sample to an escalated resolution module 130 for review.

When a single class is predicted by the class prediction set (e.g., the class prediction set consists of one class), the inference module 120 may automatically take one or more actions associated with the predicted class. The specific action may vary according to the different classes and the application of the computer modeling system 100. For example, the inference module 120 may transmit notifications to users of the computer modeling system 100 based at least, in part, on a class associated with the user and/or user data, may enable permissions for users of the computer modeling system to access information or further actions, may associate the class with the data sample, and so forth. When the inference module 120 applies the classification model 140 and the resulting set of classes is not a single class, the data sample may be provided to the escalated resolution module 130 for determining a class for the data sample.

The escalated resolution module 130 evaluates and resolves class membership with human for uncertain cases (i.e., when the class membership includes no classes or more than one class). That is, the escalated resolution module 130 may provide an alternative way for determining class membership that may be used when the classification model 140 is uncertain. As such, applying the classification model 140 may typically use lower computational resources or other requirements relative to the process used by the escalated resolution module 130. When the classification model 140 is relatively certain about a class, the corresponding action may thus be automatically applied, such that the higher resource use or other investment of the escalated resolution module 130 are applied only to more difficult/“uncertain” data instances. As previously noted, uncertain cases may occur when the inference module 120 finds that no classes are predicted for an input data sample or that multiple classes are predicted for an input data sample.

In additional embodiments, the inference module 120 may send the data sample and class prediction set to the escalated resolution module 130 regardless of the size of the class prediction set. For example, in some types of “human-in-the-loop” decisions, the evaluation by the classification model 140 may be used to augment human decision-making by highlighting relevant aspects, providing guided statistical information, or otherwise providing a supplemental data source for human review without supplanting human decision-making.

The escalated resolution module 130 may provide an interface for manual review by a user of the computer modeling system 100. For example, the escalated resolution module 130 may transmit information about the data sample to a user of the computer modeling system 100 to manually identify a correct class for the data sample. In some embodiments, the escalated resolution module 130 may additionally transmit the class output scores, information about the selection process (e.g., conformal scores), or other model information, alongside the data sample for human evaluation of the data sample and selection of a relevant class and associated action.

The escalated resolution module 130 may then identify a selected class that may be returned to the inference module 120 for application of one or more actions associated with the selected class.

In some embodiments, the inference module 120 and/or the escalated resolution module 130 may additionally or instead transmit a determined class for a data sample to another system or module not shown here, which may perform one or more actions responsive to the determined class.

FIG. 2. illustrates an overview of conformal scores and a conformal threshold used for class membership prediction, according to one or more embodiments. FIG. 2 shows an example class prediction set 230 determined for a particular input data sample 205. This is one example of a class membership selection process using Conformal Prediction (CP). Rather than determine a specific “most-likely” class for the data sample, the class prediction set 230 describes a set of classes that the data sample 205 may be associated with and may include the null set. Thus, the class prediction set 230 may identify a number of classes that the input data sample 205 is predicted to belong in based on a trained classification model 210 and a conformal threshold 225. For two classes x and y (e.g., a binary classifier), for example, the class prediction set may thus designate { } (the null set), {x}, {y}, or {x,y}. The output class prediction set 230 thus receives heuristic notions of uncertainty, like the output scores from the trained classification model 210 and converts them into a statistically rigorous notion of uncertainty in the form of a membership set. Thus, rather than outputting a single class (e.g. either 0 or 1 in binary classification), the set of predictions provides a statistical guarantee that the true label is in the output class prediction set 230 with a probability of at least 1−α, where α is an error rate. The number of classes in the output set for a particular input data sample 205 thus quantifies the uncertainty that the model has about the input data sample 205, such that larger sets (i.e., more classes) imply additional uncertainty about the true class membership of the input data sample 205.

To generate the class prediction set 230, features of the input data sample 205 are input to the classification model 210 to generate model class scores for each class. In the example of FIG. 2, the classification model 210 is trained to generate model class scores 215A-C, representing outputs of the model related to each of three classes. The model class scores 215A-C may represent “raw” scores related to each class and may not be normalized or otherwise relate to the relative strength of a class prediction relative to others. For example, each of the model class scores 215A-C may be an output of respective prediction heads for the classification model 210. In other examples, the model class scores 215A-C are normalized, for example, after application of a softmax function or other normalization layer to the class predictions.

The model class scores 215A-C are then evaluated to generate a respective set of class conformal scores 220A-C. The conformal scores 220A-C generally describe the relative certainty of the respective classes and may be determined in various ways. In general, a conformal score function s generates a class conformal score 220 based on one or more of the model class scores 215, where larger conformal scores indicate worse agreement between an input data sample and a predicted class. The conformal score function may vary in different embodiments. In one embodiment, the conformal score function sk for a given class k is one minus the model class score 215: (Sk=1−yₖ) where yₖ is the classification model output (the model class score 215) for class k.

In another embodiment, the conformal score function s accumulates the model class scores that are higher than the subject class score. In this embodiment, the model class scores 215 are ordered from largest to smallest, such that the class conformal score 220 is the accumulated value of the model class scores until the index of the class k. The score function thus accumulates the model class scores (in descending order) until the index of the subject class. The conformal score in this embodiment may be given by:

$${s}_{k} = {\sum }_{j = 0}^{k} {π}_{j}$$

where π is the permutation of model class scores 215 indexed in descending order (i.e., from largest model class score to smallest) with the index πₖ for class k.

The class conformal scores 220A-C are then compared with a conformal threshold 225 to determine classes that pass the conformal threshold 225. The value of each class conformal score 220 is compared with the conformal threshold 225 and each class having a class conformal score 220 below the conformal threshold 225 (when lower conformal scores represent higher agreement/certainty) is added to the class prediction set 230. During calibration of the conformal threshold 225, the conformal threshold 225 is set at a level based on an error rate, such that the class prediction set 230 is expected to have at least the true class at a rate based on the error rate used in calibration. As a result, the “true” class has a statistically guaranteed error rate with respect to membership in the class prediction set 230 (provided the tested data instance is drawn from the same distribution as the calibration dataset). When the class prediction set 230 includes more than one class or a null set, this may also represent relative uncertainty by the model, such that a tested data instance may be escalated for further determination of a relevant class.

As such, conformal scores for each class may then be evaluated with respect to a conformal threshold to determine the class prediction set. In embodiments discussed above, low conformal scores indicate higher confidence of class membership. Where low conformal scores represents higher output scores for a class and “agreement” across classes, classes with conformal scores below the conformal threshold are added to class prediction set. When the model is trained on appropriate data and the conformal scores are calibrated effectively for a dataset that is similar to new data samples, a single class qualifying for the class prediction set may thus indicate high confidence (with a statistical guarantee defined by the error rate) of the data sample belonging to the indicated class. When the class prediction set is null or includes multiple classes, either no classes or multiple classes satisfy the calibrated conformal threshold, indicating insufficient confidence about any particular class.

FIGS. 3 and 4 show example processes for training a classification model and a conformal threshold, according to one or more embodiments. As discussed above, the overall dataset used to learn parameters for the classification model and the conformal threshold may include two datasets—a training dataset 305 for training parameters of the classification model and a calibration dataset 405 for calibrating a conformal threshold 435.

Training of the classification model 315 may use any suitable computer model training process consistent with the architecture of the classification model 315. Each data instance in the training dataset 305 may be selected as an input data sample 310 and processed by parameters of the classification model 315 to generate scores for each of the classes as model class scores 320A-C. The model class scores 320A-C are then compared with a class label 330 based on a loss function to train model parameters that minimize the loss function relative to the class label 330. The loss function may be any suitable loss function for classification, such as cross-entropy/log loss and hinge loss functions. The classification model is trained with any suitable training mechanism and may include applying one or more batches of the training dataset 305 that may generate gradients that are backpropagated through layers of the classification model 315. Although one training approach is shown in FIG. 3, any suitable classification model 315 architecture and training process may be used to generate a classification model 315 that generates model class scores 320A-C.

A calibration dataset 405 may then be used as shown in FIG. 4 to determine a conformal threshold 435 that may be applied as shown in FIG. 2. Although one conformal threshold is shown in FIG. 4, in further embodiments, a distinct conformal threshold 435 may be determined for each class, such that membership of a data sample in the class is determined based on the conformal threshold associated with that class.

During training of the conformal threshold 435, the data samples of the calibration dataset 405 are processed to generate the relevant model class scores 420A-C and conformal scores 425A-C as discussed above using the classification model 415. That is, after training of the classification model, an input data sample 410 may be processed by the classification model 415 using the trained parameters to determine the predicted values for each class as represented in the model class scores 420A-C. Similarly, the class conformal scores 425A-C may be generated with respect to each class. In some embodiments, the conformal score only for a class label 430 of the input data sample 410 is generated. The class label 430 represents the “true” class for the input data sample 410 and is used to learn the conformal threshold 435 that calibrates the conformal threshold with respect to an error rate a.

To set the conformal threshold 435, the conformal threshold may be a quintile of the conformal scores based on the error rate. In one embodiment, the conformal threshold is chosen based on a calibration dataset, such that \hat{q} is the

$$\frac{⌈ ( n + 1 ) ( 1 - α ) ⌉}{n}$$

quantile of the conformal scores with respect to the true class (the class label 430) of the input data sample 410 in the calibration dataset 405 of size n. That is, the conformal threshold 435 is set, such that the probability of the true class being in the prediction set is close to 1 minus the error rate, with the closeness scaling according to the size n of the calibration dataset. In some embodiments, the error rates may differ for each class, such that the conformal threshold 435 is determined based on an error rate for each class, and the quintile of class conformal scores 425 (to determine the conformal threshold) is determined with respect to scores for each class.

When this approach is used for generating class prediction sets across multiple groups, particularly in conjunction with “human-in-the-loop” decisions, the conformal prediction may result in unintended inter-group differences in accuracy. That is, even after human evaluation with the benefit of class prediction sets, the resulting human evaluations may have increased accuracy disparity between the groups. In configurations where different group labels have different conformal prediction calibrations (e.g., a first conformal threshold calibrated for a first group to 90% confidence of the first group's data and a second conformal threshold calibrated for the second group to 90% confidence of the second group's data), this may unexpectedly result in higher accuracy disparities between groups after human evaluation, despite that both class prediction sets are calibrated to the same confidence level. A configuration in which conformal prediction is calibrated across the entire dataset is termed “marginal” conformal prediction. A configuration in which each group label is separately calibrated to a constant confidence level (e.g., 90% confidence level) is termed “conditional” conformal prediction.

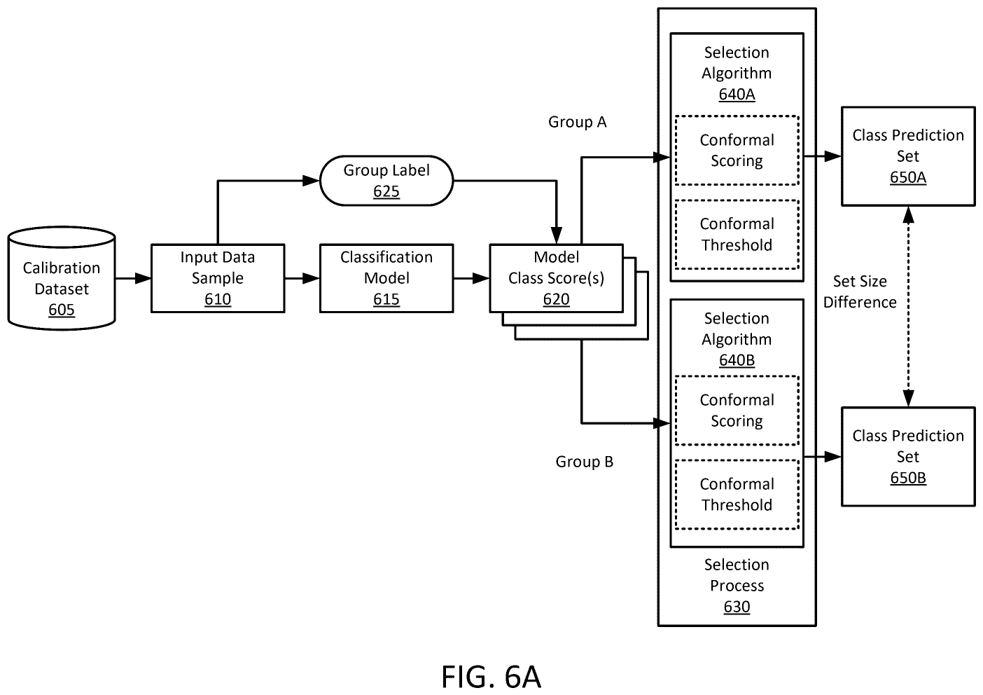

FIG. 5 shows an example of inter-group accuracy for human-in-the-loop decisions, according to one or more embodiments. FIG. 5 illustrates example of how conformal prediction, while beneficial to human-in-the-loop accuracy, can ultimately increase inter-group accuracy disparities. Particularly, this example illustrates the potential effects of inter-group accuracy that may occur when the groups inherently have different “difficulty” of evaluation according to the classification model. Initially, a set of data samples in a domain include data samples of a first group 500A (“Group e-Easy”) and a second group 50B (“Group h-Hard”).

Initially, a control group of test data samples 505A-B from each group may be provided to human reviewers without analysis or contribution from automated classification or a class membership group. The human reviewers select corresponding classes that may be evaluated with respect to known class labels (“ground truth”) to determine the human accuracy for the test data samples 505A-B as shown in chart 510.

For test data samples provided to the trained classification model 520, each of the groups 500A-B is associated with respective accuracies as shown in graph 525. As indicated, group 500A is comparatively “easier” than group 500B, such that the trained model accuracy for group 500A with respect to the labels is higher than group 500B.

When determining a marginal conformal prediction for a confidence level of 90%, the confidence level may be calibrated across all data samples of the dataset. Because the confidence level is calibrated across both the easy and the hard data samples, the “easy” data samples may more readily reach 90% confidence with smaller class prediction sets compared to the “hard” data samples as shown with graph 530. Because the overall/average coverage is calibrated across both datasets, the harder group 500B may have lower confidence offset by higher confidence of the easier group 500A.

When determining a conditional conformal prediction for a confidence level of 90%, the confidence level may be separately applied for each group to determine different conformal thresholds for each group that yields the corresponding confidence level of each group. As a result, the set sizes for the groups may also differ as shown in graph 540. Because the group 500A is comparatively easier, to calibrate for the same confidence level in both groups, fewer classes are selected compared to group 500B.

This may be illustrated with the marginal class prediction sets 550A-B for marginal conformal prediction compared with the conditional class prediction sets 560A-B for the conditional conformal prediction. When calibrating for marginal conformal prediction, the group 500A may have a higher confidence level compared to the conditional threshold, such that group 500A may have additional classes in the marginal class prediction set 550A compared to the equivalent conditional class prediction set 560A. Inversely, with marginal conformal prediction, the group 500B may have a lower confidence level compared to the conditional conformal prediction, such that the lower confidence level allows the marginal class prediction set 550B to have fewer members than the conditional conformal prediction set 560B.

Surprisingly, experiments with these approaches has revealed that, although the conditional conformal prediction may seem “more fair” because it applies the same confidence level to both groups, in practice, the human evaluation yields more unfair results. While both approaches showed improved accuracy for human review when supplemented with class prediction sets (e.g., humans are provided information about the model-predicted classes in multi-class classification problems) compared to no model information, they differed in inter-group accuracy. A chart 570 for marginal conformal prediction illustrates the improvement compared to the chart 510 of unassisted human evaluation. However, a chart 580 of the conditional conformal prediction compared to the chart 570 shows that the difference in accuracy between the groups actually increased when the class prediction sets were optimized to equalize coverage (e.g., a confidence level that the class prediction set includes the labeled class).

Rather than optimize for confidence level, when using class prediction sets with human-in-the-loop processes, the selection process for the class prediction set is determined in various embodiments by reducing the difference in set size between the class prediction sets for different groups. In various experiments, approaches that reduced the set size difference, rather than optimized for confidence level of the class prediction set, reduced the accuracy disparity between groups by human reviewers. Accordingly, to enable human-in-the-loop review that enables improved human evaluation that benefits from the model predictions without excess inter-group accuracy disparities, the selection process for the class prediction set is determined that reduces the set size difference between groups.

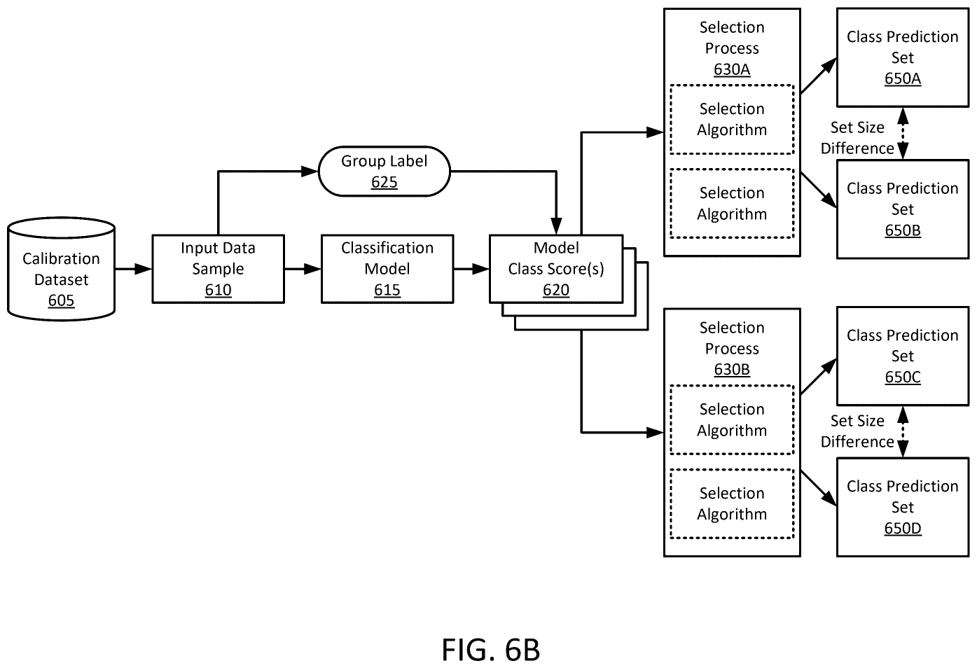

FIGS. 6A-6B show examples data flows for evaluating selection processes with a set size difference, according to one or more embodiments. The selection process for a class prediction set may be determined in various ways and may include evaluation of alternate selection processes along with modification of a selection process based on set size difference.

Initially, a calibration dataset 605 includes a set of data samples with different group labels. Each of the calibration data samples may be an input data sample 610 applied to a classification model 615 to obtain resulting model class scores 620. As discussed above, the model class scores may be logits or classification heads from the classification model and in some embodiments includes a softmax applied to the model class logits. A selection process 630 for generating class prediction sets 650A-B may include one or more selection algorithms 640. Each group may have a respective selection algorithm 640, such that a group label 625 may be used to determine the selection algorithm 640 for evaluating the model class scores 620. In this example, data samples with a group label 625 specifying group A are processed by selection algorithm 640A, and data samples with a group label 625 specifying group B are processed by selection algorithm 640B.

Each selection algorithm 640 provides a particular approach (e.g., parameters, selection protocols, etc.) for selecting a class prediction set 650 based on a set of model class scores 620. The selection algorithm 640 for different groups may thus differ across these varying dimensions within a particular selection process 630. As one example, the selection algorithm 640A may use a conformal threshold for group A that differs from a conformal threshold of the selection algorithm 640B for group B. As additional examples, selection algorithms 640 may also have different conformal scoring. For example, in addition to the conformal scoring discussed above, different types of conformal scoring (e.g., differing scoring algorithms) may be applied, such as Adaptive Prediction Sets (APS), Regularized Adaptive Prediction Sets (RAPS), and Sorted Adaptive Prediction Sets (SAPS).

In some embodiments, the selection process may use a selection algorithm that is not a conformal prediction approach that may nonetheless provide measurements of a calibrated confidence level for the resulting class prediction set. As one example of a non-CP algorithm, “avg-k” may be used that optimizes for an error rate based on a quantile of softmax scores below the specified value.

Each calibration data sample in the calibration dataset 605 may thus be evaluated by the selection process to determine respective class prediction sets 650 corresponding to each of the group labels. In the example of FIG. 6A, a particular data sample in group A may be processed by the corresponding selection algorithm 640A to obtain its class prediction set 650A. Similarly, a data sample in group B may be processed by the corresponding selection algorithm 640B to obtain its class prediction set 650B.

When determined for the set of data samples for each group label, the class prediction sets 650A for the first group and the class prediction sets 650B for the second group may be compared to determine a set size difference between them. The class prediction sets for each group may be aggregated to determine relevant information for comparison across the groups of class prediction sets 650. The inter-group set size difference may be determined based on a set size distribution across the groups (e.g., the distribution of relevant frequencies of different set sizes), a mean or mode of prediction set size (e.g., the average prediction set size), a frequency of a particular set size (e.g., single-class sets), and so forth. The set size difference between the groups may thus be determined and used as an objective for optimizing the selection process 630. Particularly, the selection process 630 is modified, selected, or calibrated to reduce the set size difference between the resulting class prediction sets across two or more groups.

The selection process 630 may be optimized to reduce the set size difference in various ways in various embodiments. As one example, the selection algorithm 640 for one group may be determined based on a confidence level (e.g., with conformal prediction calibrated to a particular confidence level), and a selection algorithm 640 for another group may be determined to reduce or minimize the set size difference, for example, by aiming to obtain a similar distribution of class prediction sets for its group. As another example, the selection process 630 may directly optimize the set size difference by calibrating the selection algorithm(s) 640 for the groups jointly and with respect to an overall confidence level. In the example shown in FIG. 5, for example, the marginal conformal prediction may be modified to allow a further difference of confidence level between groups to permit reducing the set size difference further. The determination of a selection process that reduces set size difference may also be considered as a comparison between selection processes.

FIG. 6B shows an example of determining a selection process for determining a class prediction set based on set size difference, according to one embodiment. In this example, a calibration dataset 605 may be processed as discussed in FIG. 6A to obtain model class scores 620 for the various data samples in the calibration dataset 605. Each of the datasets may be evaluated by a plurality of selection processes 630 to determine respective class prediction sets 650A-B. Each selection process 630 may be applied as discussed above with respect to FIG. 6A.

As shown in FIG. 6B, a first selection process 630A may process the model class scores 620 for the data samples according to its constituent selection algorithm(s) to obtain class prediction sets 650A-B and determine a corresponding set size difference as discussed above. The selection process 630A may include one or more selection algorithms and may include different selection algorithms that are applied based on the group label 625 of the input data sample 610. Similarly, a second selection process 630B may process the model class scores 620 to obtain class prediction sets 650C-D and determine a corresponding set size difference. The selection process 630B may also include one or more distinct selection algorithms as discussed above. As one example, one selection process may be a conformal prediction selection process and another selection process may be a non-conformal selection process. By evaluating the set size differences of the respective selection processes 630, one of the selection processes can be used in subsequent data sample evaluation with consideration for reducing the set size difference of the class prediction sets across groups.

The preferred selection process 630 may then be used in conjunction with the classification model as discussed above for determining a class prediction set to inform human evaluation.

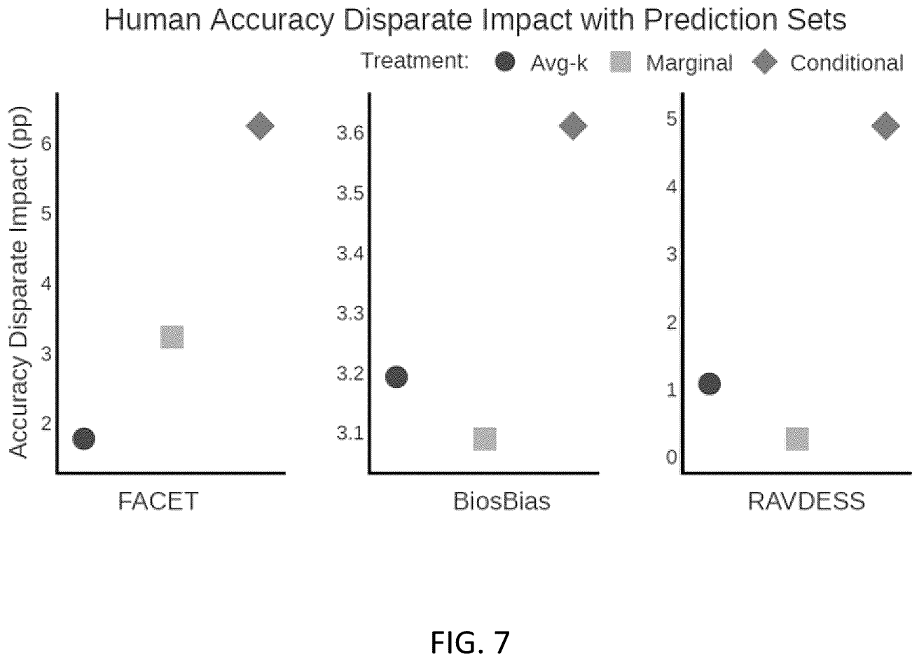

FIG. 7 shows example experimental results of various selection processes and resulting human accuracy disparity. In these experimental results, multiple datasets were evaluated with different selection processes, including Avg-k, marginal conformal prediction, and conditional conformal prediction. The FACET dataset is an image database of people with occupations that are grouped by age. The BiosBias dataset is a textual dataset that includes personal biographies classified by occupation and grouped by binary gender. The RAVDESS dataset is an audio emotion recognition dataset with classes defined by expressed emotion and labeled by binary gender. In these experiments, the data samples were processed by classification models to determine prediction sets according to the respective selection processes and human evaluators selected a class informed by the related class prediction sets. As discussed with respect to FIG. 5, in each of these experiments, the conditional conformal prediction selection process exhibited the highest disparate effect across groups. That is, the groups proposed by the models affected the humans' accuracy across groups, and the conditional conformal prediction (which ensures the same coverage across groups) performed most poorly despite its calibration to specifically include the classes providing the same confidence level across groups. Instead, the approaches allowing different confidence level across groups, and particularly the smallest set size differences, obtained preferred results. As also demonstrated in this example, in different datasets, different selection processes may result in different human-in-the-loop decisions, such that selecting the selection process that reduces set size may result in different selection processes for different datasets.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for selective model intervention, comprising:
a processor configured to execute instructions; and
a computer-readable medium having instructions executable by the processor for:
applying a classification model to a plurality of data samples having a first label or a second label, the classification model generating a plurality of model class scores for each input data sample;
determining a first inter-group set size difference of a first selection process applied to generate class prediction sets for the first label and the second label;
determining a second inter-group set size difference of a second selection process applied to generate class prediction sets for the first label and the second label; and
selecting, based on the first inter-group set size difference and the second inter-group set size difference, the first selection process or the second selection process for determining a class prediction set for human review of the data sample.

2. The system of claim 1, wherein the classification model does not receive a label as an input for an input data sample.

3. The system of claim 1, wherein the second selection process includes a conformal threshold based on the inter-group set size of the first selection process.

4. The system of claim 1, wherein the first selection process includes a first selection algorithm for the first label with a conformal threshold for the first label determined based on a confidence level and a second selection algorithm for the second label determined based on a distribution of class prediction sets of the first selection process.

5. The system of claim 1, wherein the first selection process includes a first scoring algorithm and the second selection process includes a second scoring algorithm.

6. The system of claim 1, wherein the first selection process includes a conformal prediction algorithm and the second selection process includes an avg-k selection algorithm.

7. The system of claim 1, wherein the instructions are further executable for:
receiving an inference data sample for augmented human review;
applying the classification model to the inference data sample to obtain a plurality of inference class scores;
determining an inference class prediction set with the selected first selection process or second selection process applied to the plurality of inference class scores; and
providing the inference class prediction set for human review with the inference data sample.

8. A method for selective model intervention, comprising:
applying a classification model to a plurality of data samples having a first label or a second label, the classification model generating a plurality of model class scores for each input data sample;
determining a first inter-group set size difference of a first selection process applied to generate class prediction sets for the first label and the second label;
determining a second inter-group set size difference of a second selection process applied to generate class prediction sets for the first label and the second label; and
selecting, based on the first inter-group set size difference and the second inter-group set size difference, the first selection process or the second selection process for determining a class prediction set for human review of the data sample.

9. The method of claim 8, wherein the classification model does not receive a label as an input for an input data sample.

10. The method of claim 8, wherein the second selection process includes a conformal threshold based on the inter-group set size of the first selection process.

11. The method of claim 8, wherein the first selection process includes a first selection algorithm for the first label with a conformal threshold for the first label determined based on a confidence level and a second selection algorithm for the second label determined based on a distribution of class prediction sets of the first selection process.

12. The method of claim 8, wherein the first selection process includes a first scoring algorithm and the second selection process includes a second scoring algorithm.

13. The method of claim 8, wherein the first selection process includes a conformal prediction algorithm and the second selection process includes an avg-k selection algorithm.

14. The method of claim 8, further comprising:
receiving an inference data sample for augmented human review;
applying the classification model to the inference data sample to obtain a plurality of inference class scores;
determining an inference class prediction set with the selected first selection process or second selection process applied to the plurality of inference class scores; and
providing the inference class prediction set for human review with the inference data sample.

15. A non-transitory computer-readable medium for selective model intervention, the non-transitory computer-readable medium comprising instructions executable by a processor for:
applying a classification model to a plurality of data samples having a first label or a second label, the classification model generating a plurality of model class scores for each input data sample;
determining a first inter-group set size difference of a first selection process applied to generate class prediction sets for the first label and the second label;
determining a second inter-group set size difference of a second selection process applied to generate class prediction sets for the first label and the second label; and
selecting, based on the first inter-group set size difference and the second inter-group set size difference, the first selection process or the second selection process for determining a class prediction set for human review of the data sample.

16. The non-transitory computer-readable medium of claim 15, wherein the classification model does not receive a label as an input for an input data sample.

17. The non-transitory computer-readable medium of claim 15, wherein the second selection process includes a conformal threshold based on the inter-group set size of the first selection process.

18. The non-transitory computer-readable medium of claim 15, wherein the first selection process includes a first selection algorithm for the first label with a conformal threshold for the first label determined based on a confidence level and a second selection algorithm for the second label determined based on a distribution of class prediction sets of the first selection process.

19. The non-transitory computer-readable medium of claim 15, wherein the first selection process includes a first scoring algorithm and the second selection process includes a second scoring algorithm.

20. The non-transitory computer-readable medium of claim 15, wherein the first selection process includes a conformal prediction algorithm and the second selection process includes an avg-k selection algorithm.
